(19) United States
(12) Patent Application Publication
(10) Pub. No.: US 2016/0304182 A1
(43) Pub. Date: Oct. 20, 2016

(54) TRO ANALYZER OF BALLAST WATER IN SHIP AND STRUCTURE FOR INSTALLING THE SAME

(71) Applicant: Jae yeon Park, Busan (KR)

(72) Inventor: Jae yeon Park, Busan (KR)

(21) Appl. No.: 14/726,966

(22) Filed: Jun. 1, 2015

(30) Foreign Application Priority Data
Apr. 20, 2015 (KR) 10-2015-0055550

(51) Int. Cl. B63J 4/00; G01N 27/416; G01N 27/28; G01N 27/403

(52) U.S. Cl. CPC B63J 4/002; G01N 27/403; G01N 27/4167; G01N 27/28

(57) ABSTRACT

The present invention relates to a TRO analyzer of ballast water in a ship, including: a sensor body having a plurality of electrodes and a temperature sensor insertedly disposed in one end thereof; a protection cap coupled to one end of the sensor body to protect the exposed end portions of the plurality of electrodes and the temperature sensor and having a plurality of introducing and discharging holes formed penentratedly on a portion or the whole portion thereof; a sensing chamber formed between the protection cap and the sensor body; and an ultrasonic generator fixedly disposed inside the plurality of electrodes and the temperature sensor on one end of the sensor body to discharge the ballast water introduced into the sensing chamber through the plurality of introducing and discharging holes of the protection cap.

### REFERENCE TO RELATED APPLICATIONS

This application claims the priority benefit of Korean Patent Application No. 10-2015-0055550 filed on Apr. 20, 2015, the entire contents of which are incorporated herein by reference.

### FIELD OF THE INVENTION

The present invention relates to a total residual oxidant (hereinafter, referred simply as ‘TRO’) analyzer of ballast water in a ship and a structure for installing the same, and more particularly, to a TRO analyzer of ballast water in a ship that is adapted to measure TRO of sterilized ballast water flowing along a main ballast pipe of the ship and to a structure for installing the same.

### BACKGROUND OF THE INVENTION

Generally, ballast water is sea water or fresh water stored in a ballast tank of a ship so as to maintain balance and provide optimal speed and efficiency during a voyage of the ship, and accordingly, marine lives like a variety of bacteria or plankton growing in a region where ballast water is filled in the ballast tank of the ship are moved to sea coasts in other regions along the voyage route of the ship. In this case, if the ballast water is discharged from the ballast tank so as to adjust the buoyancy of the ship, without having any separate sterilization or purification, indigenous ecosystem of the corresponding region may be seriously disturbed or destructed. So as to solve the above-mentioned problems through the management and control of the ballast water of the ship coming into port, ‘ballast water management agreement’ is accepted by International Maritime Organization (IMO) on February 2004. Accordingly, a device for sterilizing ballast water of a ship is compulsorily mounted on the ship from 2009 until now, and if a ship violates the sterilization standard (IMO D-2 Standard) of ballast water of IMO, the ship receives heavy penalty like the prohibition of the arrival at port.

A variety of ballast water sterilization devices and methods have been developed in the shipbuilding field, and the representative examples are ozone treatment, electrolysis, ultraviolet treatment, and filtration. Among them, the ozone treatment and electrolysis are widely used in the sterilization and purification of the ballast water of the ship, and conventional examples of the ozone treatment and electrolysis are disclosed in Korean Patent Registration No. 769834 (on Oct. 24, 2007) and Korean Patent Registration NO. 1050396 (on Jul. 19, 2011). If the ballast water is sterilized and purified through the ozone treatment and electrolysis, a large number of oxidants are produced and still remain in the ballast water due to specific chemical reaction, and further, oxidants exist in the ballast water by means of the organic matters in the ballast water. Accordingly, if the ballast water is introduced into the ballast tank of the ship or discharged to the outside of the ship through a sea chest, the concentration of the toxic substances (oxidants) existing in the ballast water is measured with a TRO analyzer, which is disclosed in Korean Patent Application Laid-Open No. 2010-105012 (on Sep. 29, 2010). According to the measured results, the sterilization efficiency is analyzed, or a neutralizer is poured into the ballast water so as to decrease the concentration of the oxidants up to the allowable discharging range when the ballast water is discharged to the outside of the ship. When the ballast water sterilized by the ozone treatment or the electrolysis is discharged to the outside of the ship, accordingly, the oxidants existing in the ballast water are rapidly neutralized with an appropriate amount of neutralizer, thus controlling the toxicity of the discharged water to protect the marine ecosystem.

At this time, a TRO analyzer for measuring the TRO of the ballast water introduced and discharged through the main ballast pipe is generally connected to a sampling pipe branched from the main ballast pipe into which the ballast water is introduced, as disclosed in Korean Patent Application Laid-Open No. 2013-123769 (on Nov. 13, 2013), and accordingly, the TRO is measured with only a portion of the ballast water through the sampling pipe having a smaller diameter than the main ballast pipe, so that there is a big difference between the concentration of the TRO of the ballast water in the main ballast pipe and the concentration of the TRO of the ballast in the sampling pipe, thus having the limitation in the accurate measurement of the TRO of the ballast water. Further, both ends of the sampling pipe are connected to two positions of the main ballast pipe, and in this case, if two TRO analyzers are mounted upon the introduction and discharge of the ballast water, respectively, two sampling pipes should be connected to four positions of the main ballast pipe, respectively, so that the interior of the ship wherein an ozone supply device or electrolysis device for sterilization and purification of ballast water is installed may be more complicated with the sampling pipes.

### SUMMARY OF THE INVENTION

Accordingly, the present invention has been made in view of the above-mentioned problems occurring in the prior art, and it is an object of the present invention to provide a TRO analyzer of ballast water in a ship and a structure for installing the same wherein the TRO analyzer is directly inserted into a main ballast pipe through which the ballast water is introduced and discharged or to an auxiliary ballast pipe branched from the main ballast pipe if necessary, thus making the installation structure simplified, wherein a protection cap having a plurality of introducing and discharging holes is coupled to one end of a sensor body of the TRO analyzer, thus deceasing the pressure of the ballast water introduced into the TRO analyzer, filtering the foreign matters in the ballast water, and allowing the introduction and discharge of the ballast water to be gently conducted by the generation of the ultrasound from an ultrasonic generator, without having any pump, and wherein the scales produced on the end portions of a plurality of electrodes are automatically cleaned, thus constantly maintaining the accuracy of the measurement of the TRO.

To accomplish the above-mentioned object, according to a first aspect of the present invention, there is provided a TRO analyzer of ballast water in a ship, the TRO analyzer including: a sensor body having a plurality of electrodes and a temperature sensor insertedly disposed in one end thereof in such a manner as to be exposed to the outside on one end thereof, the plurality of electrodes being adapted to sense the TRO and pH of the ballast water and the temperature sensor being adapted to sense a temperature of the ballast water; a protection cap coupled to one end of the sensor body to protect the exposed end portions of the plurality of electrodes and the temperature sensor disposed in the sensor body and having a plurality of introducing and discharging holes formed penentratedly on a portion or the whole portion thereof; a sensing chamber formed between the protection cap and the sensor body by means of the protection cap coupled to one end of the sensor body to allow the ballast water to be introduced thereinto through the plurality of introducing and discharging holes of the protection cap; and an ultrasonic generator fixedly disposed inside the plurality of electrodes and the temperature sensor on one end of the sensor body to discharge the ballast water introduced into the sensing chamber through the plurality of introducing and discharging holes of the protection cap.

According to the present invention, preferably, the TRO analyzer further includes cleaning means adapted to clean scales adhering to the exposed end portions of the plurality of electrodes and the temperature sensor by means of the vibrations produced by the ultrasound generated from the ultrasonic generator or the movements of a plurality of balls accommodated into the sensing chamber.

To accomplish the above-mentioned object, according to a second aspect of the present invention, there is provided a structure for installing a TRO analyzer of ballast water in a ship, the TRO analyzer having a sensor body having a plurality of electrodes and a temperature sensor insertedly disposed in one end thereof, the plurality of electrodes being adapted to sense the TRO and pH of the ballast water and the temperature sensor being adapted to sense a temperature of the ballast water, a protection cap coupled to one end of the sensor body and having a plurality of introducing and discharging holes formed penentratedly thereon, and a sensing chamber formed between the protection cap and the sensor body coupled to each other, the structure including: a main ballast pipe adapted to introduce and discharge the ballast water thereinto and therefrom and having an installation hole formed penetratedly on one side thereof by means of hot tapping; an auxiliary ballast pipe branched from the main ballast pipe and having an auxiliary installation hole formed penetratedly on one side thereof by means of hot tapping; and a connection valve coupled to the installation hole or the auxiliary installation hole by means of a flange or screw in such a manner as to communicate with the main ballast pipe or the auxiliary ballast pipe and having a control lever mounted thereon to open and close the connection valve, wherein the protection cap coupled to one end of the sensor body to form the sensing chamber at the inside thereof is insertedly coupled to one end of the connection valve in such a manner as to be located at the inside of the main ballast pipe or the auxiliary ballast pipe.

According to the present invention, preferably, the connection valve has a ball valve structure having a spherical disc located at the center thereof and an inlet and an outlet formed on both sides of the spherical disc in such a manner as to communicate with a through hole formed on the center of the spherical disc, and the connection valve further has tight-closing rings insertedly disposed on the inner periphery of the inlet of the connection valve coupled to the main ballast pipe or the auxiliary ballast pipe and on the inner periphery of the outlet of the connection valve coupled to the TRO analyzer in such a manner as to be brought into close contact with the outer periphery of the sensor body of the TRO analyzer to prevent the leakage of the ballast water in the main ballast pipe or the auxiliary ballast pipe when the TRO analyzer is insertedly passed through the connection valve.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a TRO analyzer of ballast water in a ship according to the present invention;

FIG. 2 is a partial sectional view showing main parts of the TRO analyzer according to the present invention;

FIG. 3 is a sectional view showing a portion of a structure for installing the TRO analyzer according to the present invention;

FIG. 4 is an exemplary view showing the TRO analyzers according to the present invention mounted on a main ballast pipe;

FIG. 5 is a perspective view showing a connection valve and an installation hole in a structure for installing the TRO analyzer according to the present invention; and

FIG. 6 is an exemplary view showing the TRO analyzer according to the present invention mounted on an auxiliary ballast pipe branched from the main ballast pipe.

### DETAILED DESCRIPTION OF THE INVENTION

The present invention relates to a TRO analyzer of ballast water in a ship that is mounted on a main ballast pipe to measure the TRO of ballast water in a ship flowing along the main ballast pipe when the ballast water is introduced into a ballast tank through a sea chest or discharged from the outside of the ship, thus maintaining the balance and providing optimal speed and efficiency during a voyage of the ship, and to a structure for installing the TRO analyzer. Hereinafter, an explanation on a TRO analyzer of ballast water in a ship and a structure for installing the same according to the present invention will be in detail given with reference to the attached drawing.

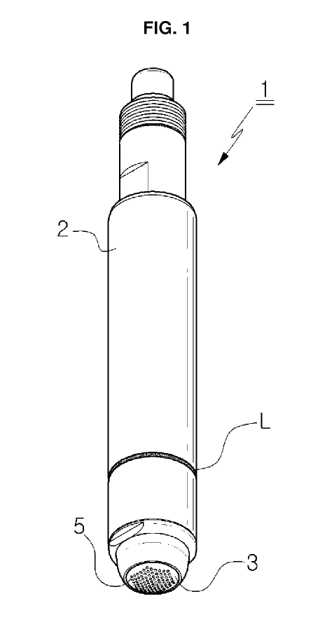

As shown in FIG. 1, a TRO analyzer 1 of ballast water in a ship according to the present invention includes a sensor body 2, a protection cap 3 coupled to one end of the sensor body 2, and a junction box coupled to the other end of the sensor body 2 opposed to one end with which the protection cap 3 is coupled.

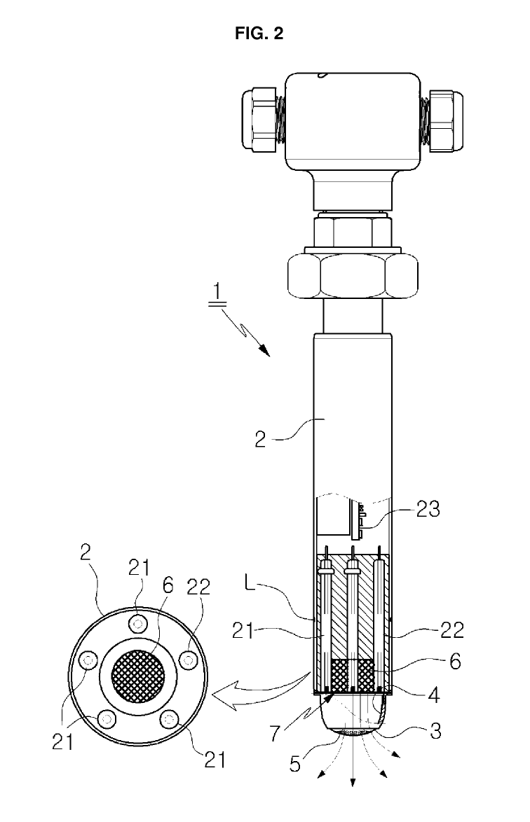

As shown in FIG. 2, the sensor body 2 of the TRO analyzer of ballast water in a ship according to the present invention includes a plurality of electrodes 21 insertedly disposed inside one end thereof in such a manner as to be electrically connected to a PCB 23 located in the interior thereof and exposed on the end portions thereof to the outside, and the plurality of electrodes 21 serves to sense TRO and pH of the ballast water in the ship. The plurality of electrodes 21 includes one gold electrode and three platinum electrodes. Accordingly, a pair of gold and platinum electrodes 21 detects the TRO by means of potential difference, and a pair of platinum electrodes 21 detects the pH by means of potential difference. Further, the sensor body 2 includes a temperature sensor 22 insertedly disposed inside one end thereof in such a manner as to be electrically connected to the PCB 23 located in the interior thereof and exposed on the end portion thereof to the outside, together with the plurality of electrodes 21 sensing the TRO and pH, and the temperature sensor 22 serves to sense a temperature of the ballast water in the ship.

According to the present invention, the TRO analyzer of ballast water in a ship has a main purpose for measuring the TRO, but further has a function for detecting salinity through the measurement of conductivity caused by small changes through the plurality of electrodes 21 and the temperature sensor 22.

The protection cap 3 is coupled to one end of the sensor body 2 having the plurality of electrodes 21 sensing the TRO and pH of the ballast water in the ship and the temperature sensor 22 measuring the temperature of the ballast water disposed exposedly therefrom, so as to protect the exposed end portions of the plurality of electrodes 21 and the temperature sensor 22. The protection cap 3 is coupled to one end of the sensor body 2 in which the plurality of electrodes 21 and the temperature sensor 22 are disposed, thus forming a sensing chamber 4 between the protection cap 3 and the sensor body 2 in such a manner as to allow the ballast water to be introduced and stored therein.

At this time, the protection cap 3 has a plurality of introducing and discharging holes 5 formed penetratedly on a portion or the whole thereof, and when the sensor body 2 is coupled to a main ballast pipe 10 in such a manner that the protection cap 3 is located inside the main ballast pipe 10, the plurality of introducing and discharging holes 5 serves to allow the ballast water flowing along the main ballast pipe 10 to be introduced into the sensing chamber 4 formed inside the protection cap 3.

Further, an ultrasonic generator 6 is fixedly disposed inside the plurality of electrodes 21 and the temperature sensor 22 on one end of the sensor body 2 in which the sensing chamber 4 is formed through the coupling with the protection cap 3, and the ultrasonic generator 6 is electrically connected to the PCB 23 and operates with the supply of electricity thereto, thus emitting ultrasound to the ballast water introduced into the sensing chamber 4 to allow the ballast water to be discharged to the main ballast pipe 10 through the plurality of introducing and discharging holes 5 formed on the protection cap 3 under the principle of cavitation.

The ultrasonic generator 6 operates every given time to discharge the ballast water to the main ballast pipe 10 through the plurality of introducing and discharging holes 5 formed on the protection cap 3 after the TRO, pH and temperature of the ballast water introduced into the sensing chamber 4 within the protection cap 3 have been measured. For example, the ultrasonic generator 6 operates one time every 75 seconds to discharge the ballast water introduced into the sensing chamber 4 within the protection cap 3, and the TRO, pH and temperature of the ballast water are measured in the unit of 75 seconds, so that if the measured value of the TRO exceeds an allowable discharging range, a neutralizer is introduced into the ballast water in the main ballast pipe 10. The neutralizer includes Na₂S₂O₃, CaO or Ca(OH)₂, Na₂Co₃, NaOH, and ammonia gas.

Further, cleaning means 7 is disposed on the exposed end portions of the plurality of electrodes 21 sensing the TRO and pH of the ballast water and the temperature sensor 22 measuring the temperature of the ballast water so as to clean scales adhering to the plurality of electrodes 21 and the temperature sensor 22, thus preventing the sensitivity of the plurality of electrodes 21 and the temperature sensor 22 from being decreased due to the adhesion of the oxidants produced upon ozone treatment or electrolysis conducted for the sterilization and purification of the ballast water or oxidants produced by the organic matters of the ballast water to the plurality of electrodes 21 and the temperature sensor 22.

The cleansing means 7 for cleaning the scales adhering to the plurality of electrodes 21 and the temperature sensor 22 conducts the cleaning through the vibrations generated when the ultrasonic generator 6 disposed inside one end of the sensor body 2 generates the ultrasound to allow the ballast water to be discharged through the plurality of introducing and discharging holes 5 to the outside of the protection cap 3 from the sensing chamber 4. Even if not shown, otherwise, a plurality of small-sized balls having a larger diameter than the plurality of introducing and discharging holes 5 is disposed inside the sensing chamber 4 at the interior of the protection cap 3, and accordingly, cleaning is conducted by means of the movements of the balls when the ballast water is introduced into the sensing chamber 4 or discharged to the outside of the protection cap 3.

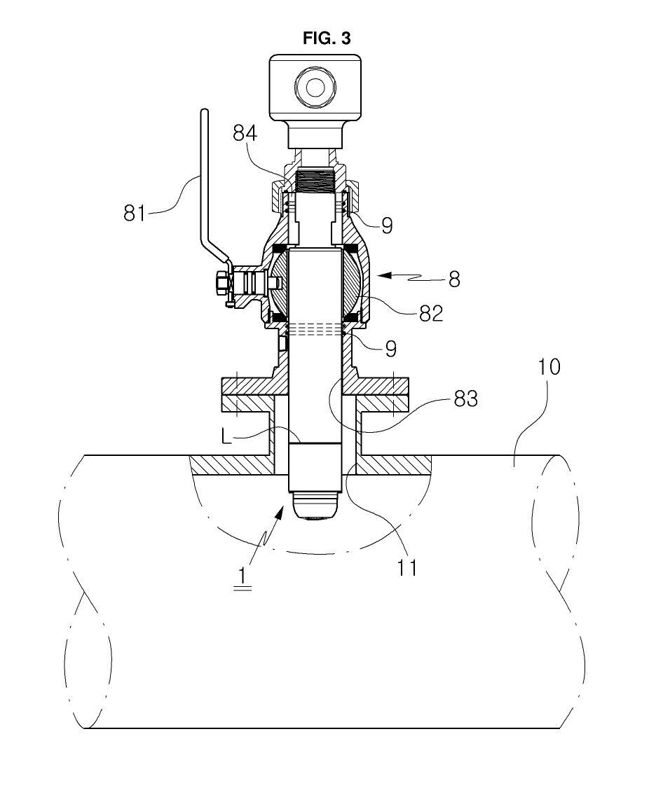

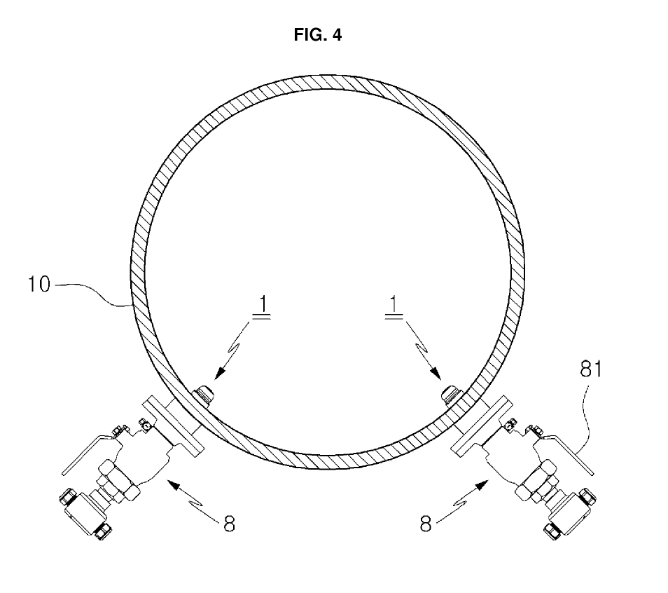

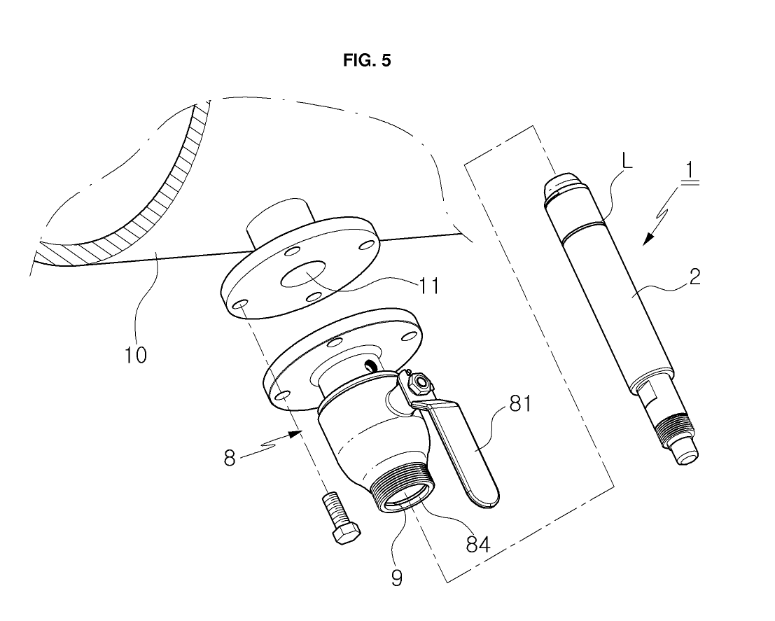

As shown in FIGS. 3 and 4, a structure for installing the TRO analyzer 1 of the ballast water in the ship according to the present invention is configured to insert, the TRO analyzer 1 having the sensor body 2 having the plurality of electrodes 21 sensing the TRO and pH of the ballast water and the temperature sensor 22 sensing the temperature of the ballast water insertedly disposed on one end thereof, the protection cap 3 coupled to one end of the sensor body 2 and having the plurality of introducing and discharging holes 5 formed penetratedly thereon, and the sensing chamber 4 formed between the sensor body 2 and the protection cap 3, into the main ballast pipe 10 through which the ballast water is introduced and discharged. As shown in FIG. 5, an installation hole 11 is formed penetratedly on one side of the main ballast pipe 10 by means of hot tapping, and a connection valve 8 is coupled to the installation hole 11 by means of a flange or screw (by means of the flange in the drawing) in such a manner as to communicate with the main ballast pipe 10. The connection valve 8 includes a control lever 81 protruding from one side thereof in such a manner as to rotate to 90°, thus opening and closing the connection valve 8, and the connection valve 8 has a ball valve structure in which a spherical disc 82 is located at the center thereof and an inlet 83 and an outlet 84 are formed on both sides of the spherical disc 82 in such a manner as to communicate with a through hole formed on the center of the spherical disc 82.

The connection valve 8 is coupled on one end thereof with the TRO analyzer 1 of the ballast water in such a manner that the protection cap 3 coupled to one end of the sensor body 2 to form the sensing chamber 4 at the interior thereof is located at the inside of the main ballast pipe 10. At this time, a pair of tight-closing rings 9 is insertedly disposed on the inner periphery of the inlet 83 of the connection valve 8 coupled to the main ballast pipe 10 and on the inner periphery of the outlet 84 of the connection valve 8 coupled to the TRO analyzer 1 of the ballast water, respectively, thus being brought into close contact with the outer periphery of the sensor body 2 of the TRO analyzer 1 when the TRO analyzer 1 is insertedly passed through the inner peripheries of the inlet 83 and the outlet 84 of the connection valve 8. The pair of tight-closing rings 9 insertedly disposed on the inner peripheries of the inlet 83 and the outlet 84 serves to prevent the ballast water in the main ballast pipe 10 from leaking to the space between the outer periphery of the sensor body 2 and the inner periphery of the connection valve 8, and if a pressure in the main ballast pipe 10 becomes low, one tight-closing ring 9 may be disposed on the inlet 83 and the outlet 84, respectively.

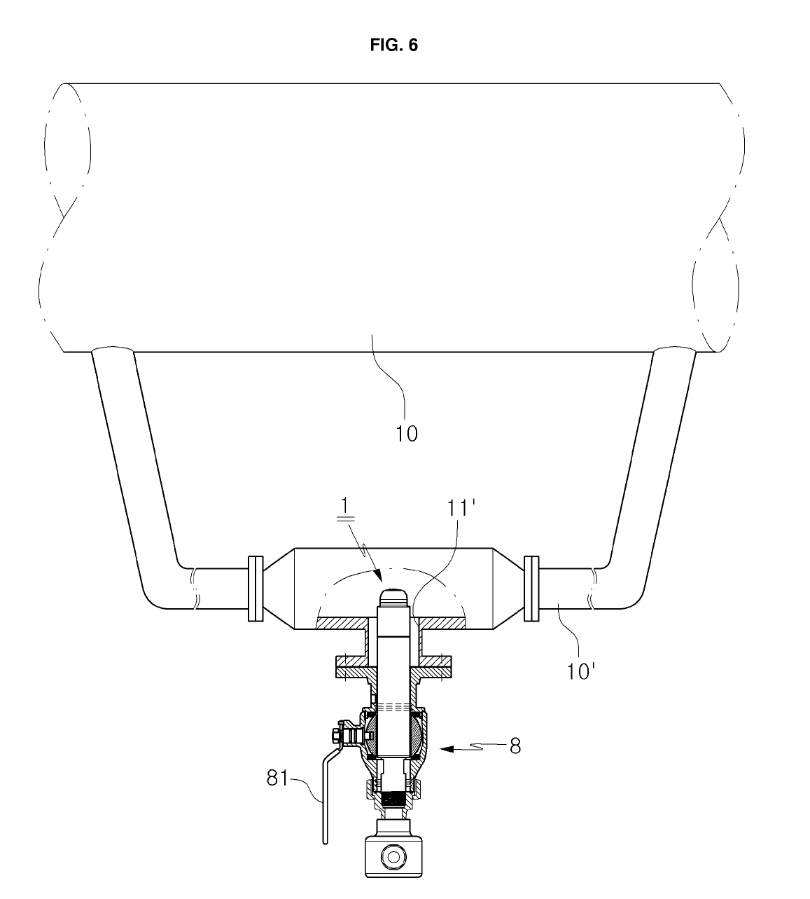

According to another example of the structure for installing the TRO analyzer 1, if the ballast water is not sufficiently introduced into the sensing chamber 4 of the TRO analyzer 1 inserted directly into the main ballast pipe 10 or if desirable sensing is not induced due to specific environments on the ship, as shown in FIG.6, the TRO analyzer 1 may be insertedly installed in an auxiliary ballast pipe 10′ branched from the main ballast pipe 10 through which the ballast water is introduced and discharged. In more detail, the auxiliary ballast pipe 10′ is bypassed on the underside of the main ballast pipe 10 in such a manner as to have a smaller diameter than the main ballast pipe 10, and at this time, the introducing front ends of the auxiliary ballast pipe 10′ are inwardly protruded in the shape of ‘L’ in such a manner as to gently introduce the ballast water in the main ballast pipe 10 into the auxiliary ballast pipe 10′, and further, a portion of the auxiliary ballast pipe 10′ is expanded to form an auxiliary installation hole 11′ on one side of the expanded pipe in such a manner as to be penetrated on the auxiliary ballast pipe 10′ by means of hot tapping. Next, the connection valve 8 is coupled to the auxiliary installation hole 11′ by means of a flange or screw in such a manner as to communicate with the main ballast pipe 10 and is open and closed by means of the control lever 81. After that, the connection valve 8 is coupled on one end thereof with the TRO analyzer 1 of the ballast water in such a manner that the protection cap 3 coupled to one end of the sensor body 2 to form the sensing chamber 4 at the interior thereof is located at the inside of the auxiliary ballast pipe 10′.

According to the present invention, the TRO analyzer 1 is provided with the sensor body 2, the protection cap 3 coupled to one end of the sensor body 2 and having the plurality of introducing and discharging holes 5 formed penetratedly thereon, and the ultrasonic generator 6 for discharging the ballast water introduced into the sensing chamber 4 formed inside the protection cap 3, and the structure for installing the TRO analyzer 1 is configured wherein the protection cap 3 and the sensing chamber 4 are insertedly located in the main ballast pipe 10 or the auxiliary ballast pipe 10′ through the connection valve 8 having the ball valve structure flange or screw-coupled to the installation hole 11 or the auxiliary installation hole 11′ formed by means of the hot tapping on the main ballast pipe 10 or the auxiliary ballast pipe 10′.

Now, an explanation on the operations of the TRO analyzer 1 and the structure for installing the TRO analyzer 1 will be given in more detail.

If a pair of TRO analyzers 1 is installed at an angle of 90° on both sides of the underside of the main ballast pipe 10 through which the ballast water is introduced and discharged, first, the installation holes 11 are formed penentratedly on one side of the main ballast pipe 10 at which the TRO analyzers 1 are installed, by means of hot tapping, and the flange coupling or screw tapping is conducted for the installation holes 11 according to the coupling structure of the connection valve 8. After that, the connection valves 8 are coupled to the installation holes 11 through the flange or screw coupling, and in the state where the connection valves 8 are closed by means of the manipulation of each control lever 81, they are fixedly mounted on the main ballast pipe 10 or the auxiliary ballast pipe 10′.

After that, the TRO analyzer 1 having the sensor body 1, the protection cap 3 coupled to one end of the sensor body 2 and having the plurality of introducing and discharging holes 5 formed penentratedly thereon, and the ultrasonic generator 6 fixedly disposed on one end of the sensor body 2 in which the sensing chamber 4 is formed is insertedly disposed into the main ballast pipe 10 through the connection valve 8, and in the state where the connection valve 8 is closed, one end of the TRO analyzer 1 to which the protection cap 3 is coupled is inserted into the outlet 84 formed at the opposite side to the inlet 83 of the connection valve 8 coupled to the installation hole 11 of the main ballast pipe 10 or to the auxiliary installation hole 11′ of the auxiliary ballast pipe 10′. At this time, an indication line L is formed at the position just before the protection cap 3 of the TRO analyzer 1 is brought into contact with the spherical disc 82 of the connection valve 8, so that when the TRO analyzer 1 is inserted into the outlet 84, it is inserted up to the indication line L, and the connection valve 8 is open by means of the manipulation of the control lever 81 of the connection valve 8, the TRO analyzer 1 is more deeply inserted into the connection valve 8. As a result, if the protection cap 3 is passed through the inlet 83 and inserted into the main ballast pipe 10 or the auxiliary ballast pipe 10′, the protection cap 3 is located inside the main ballast pipe 10 or the auxiliary ballast pipe 10′ to allow the ballast water to be introduced into the sensing chamber 4 through the plurality of introducing and discharging holes 5. At this time, the TRO and pH of the ballast water flowing along the main ballast pipe 10 or the auxiliary ballast pipe 10′ are sensed by means of the plurality of electrodes 21, while the temperature of the ballast water is being sensed by means of the temperature sensor 22.

After that, the ballast water staying in the sensing chamber 4 is discharged to the main ballast pipe 10 or the auxiliary ballast pipe 10′ through the plurality of introducing and discharging holes 5 of the protection cap 3 under the operation of the ultrasonic generator 6 of the TRO analyzer 1. After discharging, the ballast water flowing again along the main ballast pipe 10 or the auxiliary ballast pipe 10′ is automatically introduced through the plurality of introducing and discharging holes 5. Through the repetition of the periodical discharge of the ballast water by means of the ultrasonic generator 6 and the automatic introduction of the ballast water by means of the plurality of introducing and discharging holes 5, so as to introduce the ballast water into the ballast tank or to discharge the ballast water from the ballast tank to the outside of the ship, the TRO, pH and temperature of the ballast water flowing along the main ballast pipe 10 or the auxiliary ballast pipe 10′ are measured every period and monitored in real time. Further, the ballast water discharged to the outside of the ship is neutralized by means of a neutralizer, thus preventing sea pollution and minimizing ecosystem destruction.

If the TRO analyzer 1 inserted into the main ballast pipe 10 or the auxiliary ballast pipe 10′ is separated therefrom for exchanging or repairing, the TRO analyzer 1 is slowly drawn from the connection valve 8, and during this process, if the indication line L is exposed from the outlet 84 of the connection valve 8, the connection valve 8 is closed by means of the manipulation of the control lever 81. After that, the TRO analyzer 1 is completely drawn from the connection valve 8, thus minimizing the discharging of the ballast water.

According to the present invention, further, the TRO analyzer 1 is configured to allow the ballast water in the main ballast pipe 10 or the auxiliary ballast pipe 10′ to be introduced and discharged thereinto and therefrom by means of the protection cap 3 having the plurality of introducing and discharging holes 5 formed penentratedly thereon and the ultrasonic generator 6, so that there is no separate pump or pumping structure, thus making the structure of the TRO analyzer 1 simplified, saving the manufacturing cost thereof, conducting the operations for mounting and separating the TRO analyzer 1 on and from the main ballast pipe 10 or the auxiliary ballast pipe 10′ with easiness, and improving the mounting and separating efficiencies of the TRO analyzer 1.

As described above, the TRO analyzer of ballast water in the ship according to the present invention is configured wherein the protection cap having the plurality of introducing and discharging holes formed penetratedly thereon is coupled to one end of the sensor body, thus forming the sensing chamber in the space between the protection cap and the sensor body coupled to each other, and the ultrasonic generator is fixedly disposed on one end of the sensor body, so that the TRO of the ballast water can be frequently measured, and a degree of accuracy in measurement of TRO and pH through the plurality of electrodes can be improved since the pressure of the ballast water flowing along the main ballast pipe or the auxiliary ballast pipe at a given pressure is decreased by means of the plurality of introducing and discharging holes of the protection cap. Further, the protection cap having the plurality of introducing and discharging holes blocks the introduction of foreign matters into the ballast water of the ship to improve the accuracy in the measurement of the concentration of the TRO, while protecting the plurality of electrodes and the temperature sensor, and even if there is no separate pump for introducing and discharging the ballast water into and from the sensing chamber inside the protection cap, furthermore, the ballast water is gently introduced through the plurality of introducing and discharging holes formed penentratedly on a portion of the protection cap or the whole protection cap. After that, as the ultrasonic generator operates every given time to discharge the ballast water, the ballast water is gently discharged to the outside of the protection cap through the plurality of introducing and discharging holes. Accordingly, the TRO analyzer of ballast water in the ship according to the present invention can be simple in configuration and improved in operating reliability.

Additionally, the structure for installing the TRO analyzer of ballast water in the ship according to the present invention is configured to insert the TRO analyzer having the sensor body, the protection cap coupled to one end of the sensor body and having the plurality of introducing and discharging holes formed penentratedly thereon, and the sensing chamber formed between the sensor body and the protection cap, into the main ballast pipe or the auxiliary ballast pipe through which the ballast water is introduced and discharged by means of the connection valve, so that the TRO analyzer is directly inserted into the main ballast pipe or the auxiliary ballast pipe in such a manner as that the protection cap is located inside the main ballast pipe or the auxiliary ballast pipe, thus measuring the TRO in more gentle and accurate manners, making the installation structure simplified, and reducing the installation area to allow the structure to be very adequate for the ships having small internal areas.

Furthermore, the TRO analyzer of ballast water in the ship according to the present invention is configured to clean the scales adhering to the exposed end portions of the plurality of electrodes sensing the TRO and pH of the ballast water and the temperature sensor sensing the temperature of the ballast water by means of the vibrations generated from the ultrasonic generator every given time, the scales being formed by the large number of oxidants produced during the sterilization and purification of the ballast water through the ozone treatment or the electrolysis of the ballast water or formed by the organic matters in the ballast water, and otherwise, to clean the scales by means of the movements of the plurality of balls accommodated into the sensing chamber when the ballast water is introduced or discharged, so that the plurality of electrodes and the temperature sensor can be automatically cleaned, thus constantly maintaining the accuracy of the measurement of the TRO.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A total residual oxidant (TRO) analyzer of ballast water in a ship, the TRO analyzer comprising:
a sensor body 2 having a plurality of electrodes 21 and a temperature sensor 22 insertedly disposed in one end thereof in such a manner as to be exposed to the outside on one end thereof, the plurality of electrodes 21 being adapted to sense the TRO and pH of the ballast water and the temperature sensor 22 being adapted to sense a temperature of the ballast water;
a protection cap 3 coupled to one end of the sensor body 2 to protect the exposed end portions of the plurality of electrodes 21 and the temperature sensor 22 disposed in the sensor body 2 and having a plurality of introducing and discharging holes 5 formed penentratedly on a portion or the whole portion thereof;
a sensing chamber 4 formed between the protection cap 3 and the sensor body 2 by means of the protection cap 3 coupled to one end of the sensor body 2 to allow the ballast water to be introduced thereinto through the plurality of introducing and discharging holes 5 of the protection cap 3; and
an ultrasonic generator 6 fixedly disposed inside the plurality of electrodes 21 and the temperature sensor 22 on one end of the sensor body 2 to discharge the ballast water introduced into the sensing chamber 4 through the plurality of introducing and discharging holes 5 of the protection cap 3.

2. The TRO analyzer according to claim 1, further comprising cleaning means 7 adapted to clean scales adhering to the exposed end portions of the plurality of electrodes 21 and the temperature sensor 22 by means of the vibrations produced by the ultrasound generated from the ultrasonic generator 6 or the movements of a plurality of balls accommodated into the sensing chamber 4.

3. A structure for installing a TRO analyzer 1 of ballast water in a ship, the TRO analyzer 1 having a sensor body 2 having a plurality of electrodes 21 and a temperature sensor 22 insertedly disposed in one end thereof, the plurality of electrodes 21 being adapted to sense the TRO and pH of the ballast water and the temperature sensor 22 being adapted to sense a temperature of the ballast water, a protection cap 3 coupled to one end of the sensor body 2 and having a plurality of introducing and discharging holes 5 formed penentratedly thereon, and a sensing chamber 4 formed between the protection cap 3 and the sensor body 2 coupled to each other, the structure comprising:
a main ballast pipe 10 adapted to introduce and discharge the ballast water thereinto and therefrom and having an installation hole 11 formed penetratedly on one side thereof by means of hot tapping; and
a connection valve 8 coupled to the installation hole 11 by means of a flange or screw in such a manner as to communicate with the main ballast pipe 10 and having a control lever 81 mounted thereon to open and close the connection valve 8,
wherein the protection cap 3 coupled to one end of the sensor body 2 to form the sensing chamber 4 at the inside thereof is insertedly coupled to one end of the connection valve 8 in such a manner as to be located at the inside of the main ballast pipe 10.

4. A structure for installing a TRO analyzer 1 of ballast water in a ship, the TRO analyzer 1 having a sensor body 2 having a plurality of electrodes 21 and a temperature sensor 22 insertedly disposed in one end thereof, the plurality of electrodes 21 being adapted to sense the TRO and pH of the ballast water and the temperature sensor 22 being adapted to sense a temperature of the ballast water, a protection cap 3 coupled to one end of the sensor body 2 and having a plurality of introducing and discharging holes 5 formed penentratedly thereon, and a sensing chamber 4 formed between the protection cap 3 and the sensor body 2 coupled to each other, the structure comprising:
a main ballast pipe 10 adapted to introduce and discharge the ballast water thereinto and therefrom;
an auxiliary ballast pipe 10′ branched from the main ballast pipe 10 and having an auxiliary installation hole 11′ formed penetratedly on one side thereof by means of hot tapping; and
a connection valve 8 coupled to the auxiliary installation hole 11′ by means of a flange or screw in such a manner as to communicate with the auxiliary ballast pipe 10′ and having a control lever 81 mounted thereon to open and close the connection valve 8,
wherein the protection cap 3 coupled to one end of the sensor body 2 to form the sensing chamber 4 at the inside thereof is insertedly coupled to one end of the connection valve 8 in such a manner as to be located at the inside of the auxiliary ballast pipe 10′.

5. The structure according to claim 3, wherein the connection valve 8 has a ball valve structure having a spherical disc 82 located at the center thereof and an inlet 83 and an outlet 84 formed on both sides of the spherical disc 82 in such a manner as to communicate with a through hole formed on the center of the spherical disc 82, and the connection valve 8 further has tight-closing rings 9 insertedly disposed on the inner periphery of the inlet 83 of the connection valve 8 coupled to the main ballast pipe 10 or the auxiliary ballast pipe 10′ and on the inner periphery of the outlet 84 of the connection valve 8 coupled to the TRO analyzer 1 in such a manner as to be brought into close contact with the outer periphery of the sensor body 2 of the TRO analyzer 1 to prevent the leakage of the ballast water in the main ballast pipe 10 or the auxiliary ballast pipe 10′ when the TRO analyzer 1 is insertedly passed through the connection valve 8.

6. The structure according to claim 4, wherein the connection valve 8 has a ball valve structure having a spherical disc 82 located at the center thereof and an inlet 83 and an outlet 84 formed on both sides of the spherical disc 82 in such a manner as to communicate with a through hole formed on the center of the spherical disc 82, and the connection valve 8 further has tight-closing rings 9 insertedly disposed on the inner periphery of the inlet 83 of the connection valve 8 coupled to the main ballast pipe 10 or the auxiliary ballast pipe 10′ and on the inner periphery of the outlet 84 of the connection valve 8 coupled to the TRO analyzer 1 in such a manner as to be brought into close contact with the outer periphery of the sensor body 2 of the TRO analyzer 1 to prevent the leakage of the ballast water in the main ballast pipe 10 or the auxiliary ballast pipe 10′ when the TRO analyzer 1 is insertedly passed through the connection valve 8.
